(19) United States
(12) Patent Application Publication
(10) Pub. No.: US 2021/0094845 A1
(43) Pub. Date: Apr. 1, 2021

(54) WASTEWATER TREATMENT METHOD

(71) Applicant: INNOVATIVE WATER CARE, LLC, Alpharetta, GA (US)

(72) Inventors: Maurice Paul Tax, Alpharetta, GA (US); Jerome Logie, Alpharetta, GA (US)

(73) Assignee: INNOVATIVE WATER CARE, LLC, Alpharetta, GA (US)

(21) Appl. No.: 16/970,756

(22) PCT Filed: Feb. 28, 2019
(86) PCT No.: PCT/US2019/020046

§ 371 Date: Aug. 27, 2020

Related U.S. Application Data
(60) Provisional application No. 62/638,505, filed on Mar. 5, 2018.

(51) Int. Cl. C02F 1/467; C02F 1/00

(52) U.S. Cl. CPC C02F 1/4674; C02F 2101/16; C02F 1/008; C02F 1/001

(57) ABSTRACT

The present disclosure is directed to a method of water treatment. The water is passed through an electrolytic cell which converts available chlorides to hypochlorous acid, hydroxyl radicals, or other oxidizing agents. The acid is used to reduce the chemical oxygen demand (COD), the biochemical oxygen demand (BOD), and/or the ammonia content of the water. In the absence of sufficient available chlorides, the water inlet stream may be dosed with a chloride solution (e.g. brine).

### RELATED APPLICATION

The present application is a national stage application under 35 U.S.C. 371 from PCT International application no. PCT/US2019/020046, filed Feb. 28, 2019, claiming benefit of U.S. Provisional Patent application No. 62/638,505, filed on Mar. 5, 2018, the contents of each of which are incorporated herein by reference.

### BACKGROUND

Pollutants may spread through both natural and manmade water systems. While large detritus may be relatively easy to filter, removing pollutants on the micro and nano scales presents a difficult challenge. For example, some pollutants common to both domestic and industrial sources are difficult to remove by traditional means, in many cases being hard to break down and eliminate.

In particular, even after the successful removal of waste solids, in some applications, the chemical oxygen demand (COD), biochemical oxygen demand (BOD), and ammonia levels can remain high.

Breakpoint chlorination has been used to reduce the amount of ammonia to acceptable levels, but the sodium hypochlorite used to synthesize the active agent, e.g. hypochlorous acid, is difficult to use, store, and transport. In addition, the costly equipment needed and the processing time required is often prohibitive.

In view of the above, a need exists for a wastewater treatment method which lowers COD, BOD, and ammonia levels in treated wastewater with reduced cost and effort.

### SUMMARY

In general, the present disclosure is directed to a process for treating wastewater. The process includes feeding a wastewater stream to an electrolysis cell, where the wastewater stream contains chloride ions. The wastewater stream also has an initial COD concentration, an initial BOD concentration, and an initial ammonia concentration. The process also includes converting the chloride ions into an oxidizing agent within the electrolysis cell such that the oxidizing agent is present in the wastewater stream at a concentration sufficient to reduce the COD concentration, the BOD concentration, and/or the ammonia concentration in order to form an aqueous product stream.

In some embodiments, the electrolysis cell does not produce a waste stream during the process separate from the product stream.

In some embodiments, the oxidizing agent includes hypochlorous acid and/or hydroxyl radicals.

In some embodiments, the chloride ions in the wastewater stream are added by a dosage of a chloride supply, such as a brine solution.

In some embodiments, the chloride ion concentration of the wastewater stream being fed to the electrolysis cell is present in amounts greater than about 150 mg/L, such as greater than about 200 mg/L, such as greater than about 250 mg/L.

In some embodiments, the process is a continuous process and the flow of the wastewater stream is greater than about 0.01 m³/hr, such as greater than about 0.1 m³/hr, such as greater than about 1 m³/hr, such as greater than about 10 m³/hr.

In some embodiments, the process further includes the step of filtering solids from the wastewater stream prior to feeding the wastewater stream through the electrolysis cell.

In some embodiments, the process further includes the step of recirculating a portion of the product stream back through the electrolysis cell.

In some embodiments, the process further includes the step of monitoring a flow rate through the electrolysis cell. When the electrolysis cell is in communication with a power supply, the voltage supplied to the electrolysis cell by the power supply is increased or decreased based on the monitored flow rate for increasing or decreasing respectively the amount of oxidizing agent that is produced.

In some embodiments, the electrolysis cell is operated at a voltage of from about 10 volts to about 48 volts and at a current of from about 100 amps to about 500 amps.

In some embodiments, the process further includes the step of monitoring the COD centration, the BOD concentration, and/or the ammonia concentration in the product stream. Furthermore, at least one parameter within the process may be changed if a monitored concentration is above a preset limit; the parameter being changed may include the flow rate of the wastewater stream, the amount of chloride ions in the wastewater stream, or the amount of voltage supplied to the electrolysis cell.

The present disclosure is also generally directed to a system for treating a wastewater stream. The system may include an electrolysis cell configured to receive a wastewater stream. The electrolysis cell may be configured to convert chloride ions in a wastewater stream to an oxidizing agent for lowering a COD concentration, a BOD concentration, and/or an ammonia concentration in a wastewater stream. The system may also include a flow rate monitoring device for monitoring the flow rate of a wastewater stream. The flow rate monitoring device is positioned upstream from the electrolysis cell. The system may also include a chloride supply for supplying chloride to a wastewater stream. The chloride supply may also be positioned upstream from the electrolysis cell. The system may also include a controller configured to receive information from a flow rate monitoring device. The controller, based on information received from the flow rate monitoring device, may be configured to selectively control the chloride supply for maintaining chloride concentration within a wastewater stream being fed to the electrolysis cell within preset limits.

In some embodiments, the system further includes at least one solids separating device positioned upstream from the electrolysis cell that is configured to remove solids from a wastewater stream being fed to the electrolysis cell.

In some embodiments, the electrolysis cell is in communication with a variable power supply. The power supply may be capable of increasing or decreasing voltage across the electrolysis cell for selectively increasing or decreasing respectively the amount of oxidizing agent produced by the electrolysis cell. In some embodiments, the system further includes a flow sensor that monitors a flow rate of a wastewater stream being fed to the electrolysis cell. The flow sensor may be in communication with a controller. The controller, based on information received from the flow sensor, may be configured to control the power supply to the electrolysis cell based upon a flow rate of a water stream.

In some embodiments, the system further includes a recirculation line that recirculates a product stream being emitted by the electrolysis cell back to an inlet of the electrolysis cell.

### DEFINITIONS

The term “wastewater” may be understood as any water containing undesired contaminants. For example, wastewater may include industrial byproducts, agricultural chemicals, sewage, or combinations thereof. Particular examples of wastewater sources can include wastewater produced by floriculture businesses or flower farms. For instance, wastewater includes water produced by flower bulb farms. Other wastewater sources can include ballast water, cooling water and the like. The wastewater may flow from a continuous source, be provided in batches (e.g. in collection tanks), in an intermittent pattern, or combination thereof. Wastewater may be associated with a designated effluent of a process (e.g. a liquid effluent of an industrial manufacturing process, or sewage) or may be associated with any water from a known or unknown source with known or unknown contaminants (e.g. water from stream or river).

The term “contaminants” may be understood as any particulate, liquid, chemical substance, biological material, or any other such substance whose presence in a water stream is undesired. Example contaminants may be pharmaceuticals, hormones (natural or synthetic), human and/or animal waste, microorganisms, micro-pollutants, macro-pollutants, oils, emulsions, lubricants, slimes, silts, dyes, metals, plant materials, or other pollutants.

Chemical oxygen demand (COD), biochemical oxygen demand (BOD), and ammonia concentrations are accepted as known metrics by which water quality is characterized. For example, COD may be measured according to ISO 6060:1989 (where 30 mg/L≤COD≤700 mg/L of oxygen), and BOD may be measured according to ISO 5815-1 (where 3 mg/L≤BOD≤6 g/L of oxygen) or ISO 5815-2 (where 0.5 mg/L≤BOD≤6 mg/L of oxygen). As BOD is a subset of COD, COD is always equal to or greater than BOD. Ammonia concentration refers generally to the presence of ammonia, covering both ammonia, NH₃, and ammonia ions, e.g. ammonium, NH₄⁺.

In general, however, initial COD, BOD, or ammonia levels need not meet a particular threshold in order to be affected by the treatment process of the present disclosure. As BOD and ammonia occur even in natural water sources, due to the presence of microorganisms and otherwise, it is to be understood that the adoption of COD, BOD, and ammonia as performance measurement criteria need not limit the broad application of the teachings herein.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which

FIG. 1 illustrates one embodiment of a process in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a process for treating wastewater. Of particular interest is lowering the COD concentration, BOD concentration, and ammonia concentration of a wastewater stream. The process of the present disclosure is well suited to lower COD, BOD, and ammonia concentrations with low cost and effort.

The process as disclosed herein may be scaled to suit any variety of wastewater treatment needs. For example, the process may be applied to a single household wastewater stream, to the wastewater stream of a large facility, or to the wastewater stream of a municipality. In general, the wastewater flow rate may be greater than about 0.001 m³/hr, such as greater than about 0.01 m³/hr, such as greater than about 0.1 m³/hr, such as greater than about 1 m³/hr, such as greater than about 10 m³/hr, such as greater than about 50 m³/hr, such as greater than about 100 m³/hr, such as greater than about 1000 m³/hr, such as even greater than 10000 m³/hr. In some embodiments, the flow rate is less than about 10000 m³/hr, such as less than about 1000 m³/hr, such as less than about 50 m³/hr, such as less than about 10 m³/hr, such as less than about 1 m³/hr. It is to be understood that the various values of parameters disclosed herein are given to provide example embodiments and that scaling the parameters to suit different embodiments remains within the scope of the disclosure.

In one embodiment, the COD, BOD, and/or ammonia concentrations are reduced by at least one oxidizing agent. For example, a suitable oxidizing agent is hypochlorous acid. The oxidizing agent need not be directly injected into the wastewater stream; the oxidizing agent may be synthesized during the treatment process.

One approach to synthesizing the oxidizing agent includes converting chloride ions present in the influent wastewater. For example, the chloride ions may be present in an amount greater than about 10 mg/L, such as greater than about 20 mg/L, such as greater than about 75 mg/L, such as greater than 150 mg/L, such as greater than 200 mg/L, such as greater than about 250 mg/L, such as greater than about 600 mg/L, such as greater than about 1000 mg/L, such as greater than about 2000 mg/L, such as greater than about 3000 mg/L, such as greater than about 4000 mg/L. Generally, however, the chloride ions are present in an amount less than about 10,000 mg/L, such as less than about 8000 mg/L, such as less than about 6000 mg/L, such as less than about 5000 mg/L, such as less than about 3000 mg/L, such as less than about 2000 mg/L, such as less than about 1000 mg/L, such as less than about 500 mg/L.

If desired, the amount of chloride ions in the water may be adjusted to meet a particular target amount. For example, a chloride solution (e.g. a brine of sodium chloride) may be injected into the wastewater, providing doses of chloride ions in the absence of or in supplement to any available chloride in the influent wastewater. The dosage amount may vary, providing up to 100 wt. % chloride by weight of the total amount of chloride ions or as little as 0 wt. %, such as from about 10 wt. % to 90 wt. %, such as from 40 wt. % to 60 wt. %.

In some embodiments, the wastewater stream may be injected with a brine of salt in various concentrations. For example, the brine may contain greater than about 5 wt. % salt by weight of water, such as greater than about 10 wt. %, such as greater than about 20 wt. %. Generally, however, the salt will be present in the brine in an amount less than about 28 wt. %, such as less than about 26 wt. %. The salt concentration of the brine may be adjusted to achieve various target salt concentrations in the wastewater stream; for example, at 15 wt. % salt, about 6.7 L of brine will raise the salt concentration of the wastewater by 1000 mg/L. A 25 wt. % brine will achieve the same effect with only 4 L of brine.

In some embodiments, the injection of a brine solution into the wastewater may operate according to a control system. For example, an open-loop control system may inject a prescribed volume of brine per unit volume of influent wastewater. Alternatively, a closed-loop system might actively test the salinity of the influent wastewater and dose the wastewater according to a predetermined algorithm. In another example, the dosage controller may consider other process parameters, such as the quantity of oxidizing agent being synthesized. Various sensors may be used in the construction of a control system; for example, some suitable sensors include flow rate and electrical conductivity sensors.

Advantageously, processes according to the present disclosure may make use of salt preexisting in the influent wastewater, reducing or even eliminating the need for a brine dosage.

The chloride ions available in the wastewater, whether preexisting in the influent stream or from a dosage, may be converted to an oxidizing agent by passing the wastewater into an electrolysis cell. The resultant oxidizing agent may be a chlorine compound, e.g. hypochlorous acid. In particular, hypochlorous acid is known for its disinfectant qualities. For example, in some embodiments, 3 chloride ions in the wastewater stream can produce 1 Cl₂, which will be converted to hypochlorous acid.

The electrolytic or electrolysis cell may contain at least one anode and at least one cathode. The anode or cathode may be of any number of materials known in the art. For example, the anodes and cathodes in the electrolytic cell may be of the same material, or they may be of independently chosen materials. In another example, the electrodes may be of the same material initially, but use as an anode or a cathode may alter the composition such that the anodes and the cathodes are distinct.

In some embodiments, the electrolytic cell does not have a membrane, and all reaction products remain in the treated flow. Advantageously, an electrolytic cell operating without a membrane facilitates pH stability throughout the chloride conversion process. For example, the pH may be greater than about 4, such as greater than about 5, such as greater than about 6, such as greater than about 7. Generally, the pH is lower than about 10, such as lower than about 9, such as lower than about 8.

In some embodiments, the temperature of the wastewater in the electrolytic cell may be inherited from the source wastewater. In other embodiments, the temperature may be monitored and/or controlled. For example, the temperature may be less than about 50° C., such as less than about 40° C., such as less than about 30° C., such as less than about 20° C. Generally, however, the temperature is greater than about 2° C., such as greater than about 5° C., such as greater than about 10° C.

In some embodiments, the electrical conductivity of the influent wastewater may be monitored and/or controlled for the electrolysis reaction. For example, the conductivity may be greater than about 0.1 mS/cm, such as greater than about 0.75 mS/cm, such as greater than about 1.5 mS/cm, such as greater than about 3 mS/cm. Generally, however, the conductivity is less than about 50 mS/cm, such as less than about 30 mS/cm, such as less than about 10 mS/cm, such as less than about 5 mS/cm, such as less than about 3 mS/cm.

The electrolysis reaction may be direct or mediated. Direct electrolysis is carried out on the surface of the electrodes, requiring that the target of oxidation be oxidized once adsorbed into the electrode surface. Mediated electrolysis relies a mediator which oxidizes on the surface of the anode and subsequently travels into the bulk fluid to react with the target of oxidation. One such mediator is the highly reactive hydroxyl radical (.OH). Another mediator may include the chloride present in the influent wastewater stream.

Mediated electrolysis and direct electrolysis may operate concurrently. Similarly, various mediators may operate simultaneously. For example, chloride ions may directly oxidize on the surface of an anode. In another portion of the anode, hydroxyl radicals may oxidize and travel to the bulk flow to react with chloride ions in the bulk flow. Furthermore, whether on the surface of an anode or in the bulk flow, chloride ions may oxidize into hypochlorite, another oxidant which may further oxidize other matter in the wastewater. In this manner, both hydroxyl radicals and chloride ions may concurrently act as mediators.

Of particular advantage, in some embodiments, the pollutants in the wastewater stream may be oxidized within the electrolytic cell even while the chloride is converted. Because hydroxyl radicals have a short lifespan, it is of a particular advantage that the pollutants pass over and near to the electrodes to be oxidized directly by the electrodes and the nearby hydroxyl radicals. In such embodiments, the sanitation of the wastewater is effected synergistically by both the chloride-containing oxidation agent and the direct and mediated oxidation via the electrode surfaces and the hydroxyl radicals.

Accordingly, some embodiments may feature the mainline wastewater flow passing through at least one electrolytic cell. In other embodiments, the mainstream flow may pass through a plurality of electrolytic cells in parallel. Other embodiments may direct only a portion of the mainstream wastewater flow to an electrolytic cell, the treated portion being returned to the mainstream to effect sanitation. Of particular advantage, parallel cell configurations may permit one or more cells to remain in operation while flow is redirected from one or more other cells while being serviced. Maintenance, for example, may include an acid wash to remove buildup on the cell electrodes.

The structure of the electrolytic cell may follow any design known in the art. For example, the cell may be of a unipolar configuration or a bipolar configuration. Advantageously, bipolar configurations may permit large electrode surface areas to facilitate many simultaneous oxidation reactions. Additionally, bipolar configurations may offer increased power efficiency.

For example, in some embodiments, the power requirement may be lower than about 10 kW per kg per hour for each kilogram of oxidizing agent, such as lower than about 8 kW per kg per hour, such as lower than about 5 kW per kg per hour, such as lower than about 3 kW per kg per hour. Generally, however, the power draw is greater than about 0.25 kW per kg per hour, such as greater than about 0.5 kW per kg per hour, such as greater than about 1 kW per kg per hour.

The current and voltage requirements will vary based on the cell size and design and may suitably be configured by one skilled in the art. For example, in some embodiments, the voltage supplied across the electrodes may be less than about 50 VDC, such as less than about 40 VDC, such as less than about 30 VDC. Generally, however, the voltage may be greater than about 10 VDC, such as greater than about 15 VDC, such as greater than about 20 VDC. In some embodiments, the current drawn by one cell may be less than about 500 A, such as less than about 250 A, such as less than about 150 A. Generally, however, the current will be greater than about 1 A, such as greater than about 10 A, such as greater than about 50 A, such as greater than about 100 A.

In one embodiment, the electrolytic cell is powered by a controllable power supply. For example, a flow meter upstream of the electrolytic cell may provide a signal to a controller corresponding to the volumetric flow rate, mass flow rate, and/or electrical conductivity. The controller may process the signal according to pre-programmed algorithms and send an appropriate power signal to the electrolytic cell. In such a manner, the electrolysis reaction may adapt to flow fluctuations in the influent wastewater and maintain peak performance. Similar to the optional brine dosage controller, the power supply controller may also optionally consider other process parameters, such as the measured quantity of oxidizing agent downstream of the electrolytic cell, and adjust the power signal accordingly.

In one embodiment, the electrolysis reaction may operate in a recirculation loop. As an alternative to increasing the size, quantity, and/or power of the electrolytic cell(s), both the chloride ions and the wastewater pollutants may be more fully oxidized if passed through one or more cells repeatedly. Optionally, brine may be added to the wastewater on subsequent passes if needed. For example, the electrolytic cell effluent may be recycled through the electrolytic cell in part or in whole. In one embodiment, the electrolytic cell effluent is deposited in a holding tank. A recirculation pump recycles the water in the holding tank back through the electrolysis reaction until the BOD, COD, and/or ammonia levels reach a predetermined threshold. The treated water in the tank may then be released into a treated water outlet stream.

The quality of the electrolytic cell effluent may optionally be monitored and/or controlled using various techniques. For example, the effluent may be tested for chlorine content, oxidation-reduction potential, pH, COD, BOD, ammonia, or other such parameters. Based on the output of such measurements, the effluent may by either recycled through the electrolysis reaction or may be admitted into a treated water outlet stream.

In one embodiment, a chlorine monitor may be employed to measure for any chlorine residual. A chlorine residual (i.e. chlorine that has not reacted with contaminants) may provide quick indication that the COD, BOD, and/or ammonia content has been lowered. If measured electronically, a chlorine monitor may provide a signal to at least one of the dosing controller and the power supply controller to maintain peak performance. For example, the free chlorine may be present in the treated water outlet stream in an amount greater than about 0.01 mg/L, such as greater than about 0.1 mg/L, such as greater than about 0.3 mg/L, such as greater than about 0.5 mg/L, such as greater than about 1 mg/L, such as greater than about 3 mg/L. Generally, however, free chlorine levels are lower than about 5 mg/L, such as less than about 3 mg/L, such as less than about 2 mg/L, such as less than about 1 mg/L, such as less than about 0.5 mg/L.

In one embodiment, the chlorination procedure described herein is one stage of a comprehensive water treatment process. For example, prior to passage into the electrolytic cell, the wastewater may first be filtered for solids by any filtration method known in the art. Filtration may be carried out in any number of stages.

The hydrogen gas byproduct of the electrolysis reaction may be vented and/or captured at any suitable point in the system. For example, the hydrogen may be collected or released when the treated water exits the process stream into a tank or basin.

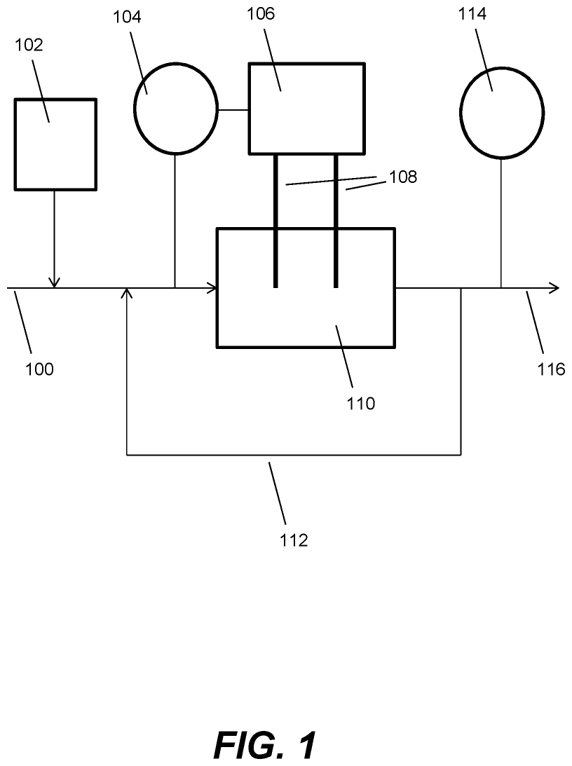

FIG. 1 illustrates one embodiment of a process in accordance with the present disclosure. A wastewater stream 100 is dosed from a brine tank 102. A power supply 106 reads a flow sensor 104 and adjusts the power to electrolytic cell electrodes 108 to optimally oxidize the electrolytic cell influent. A recirculation loop 112 may return the electrolytic cell effluent, in whole or in part, to more fully oxidize the wastewater. A chlorine or pH sensor 114 may be used to evaluate the effectiveness of the treatment and the quality of the treated water stream 116.

The steps as disclosed herein may effectively reduce the COD, BOD, and ammonia present in a wastewater stream. In some embodiments, even up to about 100% of contaminants may be removed. For example, greater than about 70% of contaminants may be removed, such as greater than 85%, such as greater than 95%. The COD may be lowered to less than about 700 mg/L, such as less than about 500 mg/L, such as less than about 200 mg/L, such as less than about 50 mg/L, such as less than about 20 mg/L, such as less than about 5 mg/L, such as less than about 1 mg/L. Generally, however, the COD may remain greater than about 0.05 mg/L, such as greater than about 0.5 mg/L such as greater than about 1 mg/L. As noted previously, the BOD is always less than or equal to COD. Ammonia concentration may be reduced to less than about 35 mg/L, such as less than 10 mg/L, such as less than about 2 mg/L, such as less than about 0.5 mg/L, such as less than about 0.1 mg/L. Generally, however, ammonia may remain greater than 0.025 mg/L.

The process as disclosed herein may, in some embodiments, be employed as a finishing or polishing step to a water treatment process. For example, after wastewater is treated by traditional methods, the presently disclosed process may reduce the final COD, BOD, and/or ammonia levels of the previously treated wastewater. In this manner, equipment designed to execute the disclosed process may be incorporated into existing water treatment facilities. For example, water purification equipment, e.g. antimicrobial devices, may pass treated wastewater into equipment according to the present disclosure for a final treatment step. Accordingly, any application of water treatment methods may employ the presently disclosed process as a finishing step.

The water treatment process as presently disclosed may be executed by permanent or temporary equipment. For example, in the event of a natural disaster, when established treatment plants are taken offline, mobile machinery equipped as described herein may be set up to temporarily provide clean water to affected communities. Alternatively, machinery equipped as described herein may be installed in replacement of aging or otherwise ineffective treatment methods. In another implementation, said machinery may operate in supplement to existing wastewater processing methods.

In some embodiments, the equipment may be scaled to compact sizes suitable for transport. For example, such equipment may be distributed to communities in underdeveloped areas to augment traditional water purification devices to improve the quality of local water sources. Compact packaging would facilitate transport across various terrain via any type of vehicle.

In one embodiment, such a unit could be installed on a truck or tractor chassis to provide easy transport and an integrated power source (e.g. the engine of the vehicle or a secondary generator).

The effectiveness of processes prepared according to the present disclosure will be demonstrated in the following example.

### EXAMPLE

In one example, 10 m³/hr domestic waste is treated by adding at least 1 kg sodium chloride per cubic meter of influent wastewater. Each electrolytic cell is run at 20-24 VDC at 125 A to produce 500 g/hr of hypochlorous acid.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged either in whole or in part. Furthermore, those of ordinary skill in the art will appreciate that the foregoing description is by way of example only, and is not intended to limit the invention so further described in such appended claims.

What is claimed:

1. A process for treating wastewater comprising:
feeding a wastewater stream to an electrolysis cell, the wastewater stream containing chloride ions, the wastewater stream having an initial COD concentration, an initial BOD concentration, and an initial ammonia concentration; and
converting the chloride ions into an oxidizing agent within the electrolysis cell, the oxidizing agent being present in the wastewater stream at a concentration sufficient to reduce at least one of the COD concentration, the BOD concentration, and the ammonia concentration in order to form an aqueous product stream.

2. The process as defined in claim 1, wherein the oxidizing agent is present in the wastewater stream at a concentration sufficient to reduce each of the COD concentration, the BOD concentration, and the ammonia concentration in order to form an aqueous product stream.

3. The process as defined in claim 1, wherein the electrolysis cell does not produce a waste stream during the process separate from the product stream.

4. The process as defined in claim 1, wherein the oxidizing agent comprises hypochlorous acid and/or hydroxyl radicals.

5. The process as defined in claim 1, wherein the chloride ions present in the wastewater stream are only those chloride ions which were preexisting in the influent wastewater stream.

6. The process as defined in claim 1, wherein the wastewater stream comprises chloride ions added by a dosage of a chloride supply.

7. The process as defined in claim 6, wherein the chloride supply is a brine solution.

8. The process as defined in claim 1, wherein the chloride ion concentration of the wastewater stream being fed to the electrolysis cell is greater than about 500 mg/L, such as greater than about 1000 mg/L, such as greater than about 3000 mg/L.

9. The process as defined in claim 1, wherein the process is a continuous process and wherein flow of the wastewater stream is greater than about 0.01 m³/hr, such as greater than about 0.1 m³/hr, such as greater than about 1 m³/hr, such as greater than about 10 m³/hr.

10. The process as defined in claim 1, further comprising the step of filtering solids from the wastewater stream prior to feeding the wastewater stream through the electrolysis cell.

11. The process as defined in claim 1, further comprising the step of monitoring a parameter of the wastewater stream being fed through the electrolysis cell, the electrolysis cell being in communication with a power supply, and wherein voltage supplied to the electrolysis cell by the power supply is increased or decreased based on the monitored parameter for increasing or decreasing respectively the amount of oxidizing agent that is produced, the parameter being flow rate and/or electrical conductivity.

12. The process as defined in claim 1, wherein the electrolysis cell is operated at a voltage of from about 10 volts to about 48 volts and at a current of from about 100 amps to about 500 amps.

13. The process as defined in claim 1, further comprising the step of monitoring the COD centration, the BOD concentration, and/or the ammonia concentration in the product stream and wherein at least one parameter within the process is changed if a monitored concentration is above a preset limit, the parameter being changed comprising the flow rate of the wastewater stream, the amount of chloride ions in the wastewater stream, or the amount of voltage supplied to the electrolysis cell.

14. A system for treating a wastewater stream comprising:
an electrolysis cell configured to receive a wastewater stream, the electrolysis cell being configured to convert chloride ions in a wastewater stream to an oxidizing agent for lowering a COD concentration, a BOD concentration, and/or an ammonia concentration in a wastewater stream;
a parameter monitoring device for monitoring a parameter of a wastewater stream, the parameter monitoring device being positioned upstream from the electrolysis cell, the parameter being flow rate and/or electrical conductivity;
a chloride supply for supplying chloride to a wastewater stream, the chloride supply being positioned upstream from the electrolysis cell; and
a controller configured to receive information from the parameter monitoring device, the controller, based on information received from the parameter monitoring device, being configured to selectively control the chloride supply for maintaining chloride concentration within a wastewater stream being fed to the electrolysis cell within preset limits.

15. The system as defined in claim 14, further comprising at least one solids separating device positioned upstream from the electrolysis cell that is configured to remove solids from a wastewater stream being fed to the electrolysis cell.

16. The system as defined in claim 14, wherein the electrolysis cell is in communication with a variable power supply, the power supply being capable of increasing or decreasing voltage across the electrolysis cell for selectively increasing or decreasing respectively the amount of oxidizing agent produced by the electrolysis cell.

17. The system as defined in claim 16, further comprising a parameter monitoring device that monitors a parameter of a wastewater stream being fed to the electrolysis cell, the parameter monitoring device being in communication with a controller, the controller, based on information received from the parameter monitoring device, being configured to control the power supply to the electrolysis cell based upon the parameter of the wastewater stream, the parameter being flow rate and/or electrical conductivity.

18. The system as defined in claim 14, further comprising a recirculation line that recirculates a product stream being emitted by the electrolysis cell back to an inlet of the electrolysis cell.
